(19) United States
(12) Patent Application Publication
(10) Pub. No.: US 2011/0041182 A1
(43) Pub. Date: Feb. 17, 2011

(54) INTRUSION DETECTION AND NOTIFICATION

(76) Inventor: John Stenfelt, Goteborg (SE)

Correspondence Address: ERICSSON INC., 6300 LEGACY DRIVE, M/S EVR 1-C-11, PLANO, TX, 75024, US

(21) Appl. No.: 12/990,040

(22) PCT Filed: Apr. 29, 2008
(86) PCT No.: PCT/EP08/55267

§ 371 Date: Oct. 28, 2010

(51) Int. Cl. G06F 12/14

(52) U.S. Cl. 726/23

(57) ABSTRACT

A device for use in a cellular communications system, the device being provided with means for inspecting traffic packets to and from users in the system and for a first classification of said packets according to predetermined rules. The device also comprises means for initiating a process for a user who is the destination or source of a packet which is classified in said first classification as belonging to a specific kind of traffic which has as one of its characteristics that the device cannot redirect the packet from its intended destination to another destination. The process is such that at a later point in time, when the user attempts to access a webpage, the user is redirected to a predefined webpage.

### TECHNICAL FIELD

The present invention discloses a device and a method for improved detection and notification of intrusion in a wireless cellular system.

### BACKGROUND

Malicious software, also known as “malware”, is the common name for all types of software or program code that are designed to infiltrate and potentially damage a computer system without its owner's informed consent. Malicious software encompasses computer viruses, Trojans, worms, spyware and in addition adware to some extent.

Examples of commonly known forms of malware are computer viruses and worms, which differ from each other primarily in the way that they spread. A virus is in principle an executable program or an infected file that requires the user to activate it, for example by executing a downloaded virus program or opening an infected document attached to an e-mail. A worm, on the other hand, spreads automatically over a network without any active intervention from the user.

The problems related to different forms of malware are increasing on the Internet today, and it is highly likely that viruses and worms which today plague stationary computers and laptops will soon also “migrate” to cellular telephones. This is particularly the case since cellular phones with an increasing ease can be used for surfing the Internet, which increases the risk of malware infections.

One way to deal with the problem of malware in cellular telephones would of course be to provide the end users (i.e. the telephones) with anti-virus solutions, such as anti-virus programs. However, cellular telephones present significant challenges for anti-virus software, such as, for example:
Memory constraints,
Processor constraints,
Providing definitions and new signature updates to the mobile handsets.

In view of these challenges, a so called intrusion detection system (IDS) or network intrusion detection system (NIDS) would seem an attractive solution to the problem of malware in cellular telephones. These systems, i.e. IDS/NIDS can be briefly explained as follows:

An intrusion detection system (IDS) monitors network traffic in a system or a device, and is capable of detecting unwanted forms of traffic such as malicious traffic from worms and viruses that are trying to spread themselves over the network.

Detecting suspicious traffic is traditionally accomplished by packet inspection, identifying heuristics and patterns (known as signatures) of common network attacks.

When an IDS “sensor” detects a potential security breach, it signals the system owner and logs the information.

Some IDS systems are reactive. These systems, known as Intrusion Prevention Systems (IPS), respond to suspicious activity by terminating the connection.

A network intrusion detection system (NIDS) is an IDS that is implemented as a standalone platform which identifies intrusions through packet inspection of traffic to and from multiple hosts.

Although seemingly attractive solutions at a first glance, introducing stand-alone NIDS/NIPS in mobile networks may have several disadvantages:
Stand alone NIDS/NIPS may introduce additional user plane latency into the system,
Packet inspection will be performed inefficiently at several instances of the network if the network uses 3GPP PCC (Policy and Charging Control):
   Once for intrusion detection purposes on the Gn side (uplink)
   Once again for policy control and charging
   Probably also a third time on the Gi side (downlink) for intrusion prevention.
Additional components in the network which will require maintenance, and which will thus lead to increased complexity for the operator, i.e.:
   Increased CAPEX.
   Risk for increased OPEX.

A particular problem is caused by malware which infects its “host” by means of traffic which is not to or from a webpage, due to the fact that if a device, with or without the consent of the user addresses a webpage which is known as a source of malware or that carries with it a high known risk of malware infection, the traffic can be interrupted by a surveillance program and redirected to a predetermined “safe” site, which may have a warning banner, so that the user may for example be instructed to run a virus scan or to download an antivirus/antimalware program.

However, if the malware infects its host by other means, there is no way in which the user of the host device can be alerted to the fact that suspicious traffic is being sent to/from the device.

### SUMMARY

Thus, as explained above, there is a need for a solution by means of which the problems stated above regarding malware prevention/removal can be reduced or eliminated. The solution should in particular be able to address the problem of malware which is carried on traffic that cannot be redirected.

Such a solution is presented by the present invention in that it discloses a device for use in a cellular communications system, which comprises means for inspecting traffic packets to and from users in the system.

The device is in addition provided with means for a first classification of the traffic packets according to predetermined rules, as well as with means for initiating a process for a user who is the destination or source of a package which is classified in said first classification as belonging to a specific kind of traffic.

The “specific kind of traffic” mentioned above has as one of its characteristics that the device cannot redirect the package from its intended destination to another destination, and the process which is initiated by the device is such that at a later point in time, when the user attempts to access a webpage, the user is redirected to a predefined webpage.

Thus, the invention can handle the case of suspicious “non-browser related” traffic in that, when possible, the user is redirected to a webpage which suitably contains a warning regarding malware infections. Suitably, this “redirect” is carried out at the first earliest opportunity, i.e. the “later point in time” mentioned above occurs the next time that the user attempts to access any webpage.

In one embodiment, the device is also provided with means for carrying out a secondary classification of said packages, and in this embodiment the device additionally comprises a first additional node which is supplied with the results of the secondary classification. The first additional node in return supplies the device with a decision on whether or not said process should be initiated.

In another embodiment, the device receives rules for the first classification from a second additional node in the system, including rules for the initiation of said process.

The invention also discloses a method for malware detection and prevention in a cellular communications system.

### BRIEF DESCRIPTION OF THE DRAWINGS

The invention will be described in more detail in the following, with reference to the appended drawings, in which

FIG. 1 shows a principle of the invention, and

FIGS. 2-4 show block diagrams of embodiments of a device of the invention, and

FIG. 5 shows a flow chart of a method of the invention.

### DETAILED DESCRIPTION

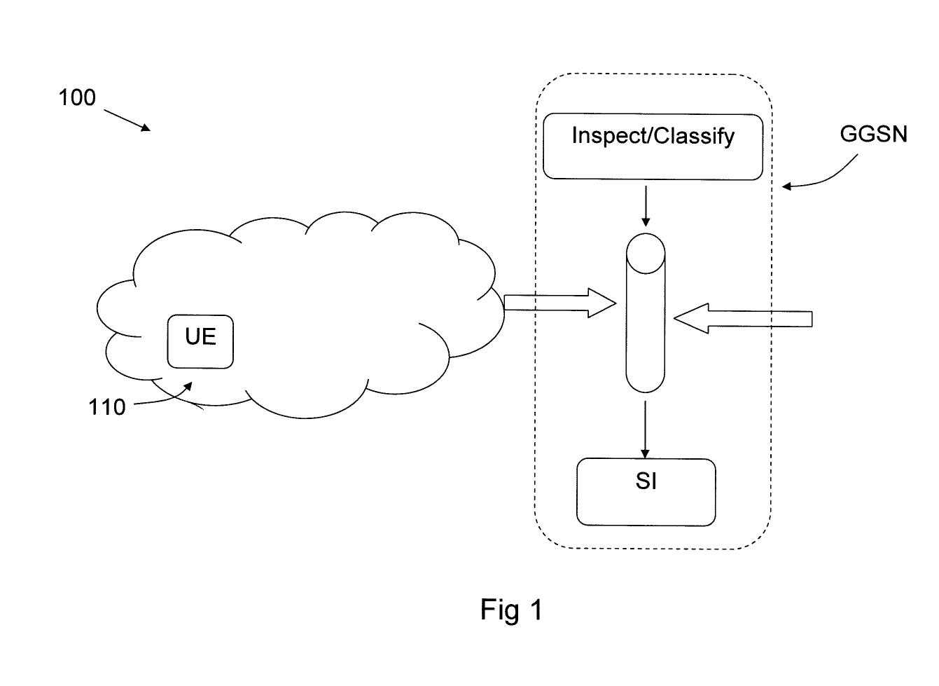

FIG. 1 schematically illustrates a principle behind the invention. However, before this principle is described it should be pointed out that in the description below, use will be made of terminology borrowed from cellular systems such as 2G/3G-systems. This is however merely in order to facilitate the reader's understanding of the invention and should not be seen as restricting the scope of protection sought for the present invention, which can equally well be applied in other cellular systems, such as for example, WLAN or LTE, Long Term Evolution, systems.

Returning now to FIG. 1, a user terminal, an “UE” 110 receives and sends traffic in a cellular system 100, the traffic being routed through a gateway such as, for example, a so called GGSN, Gateway GPRS Support Node. Part of the system 100 is illustrated schematically as a cloud, in order to indicate that there can be multiple components between the UE and the GGSN.

The traffic to and from the UE is schematically shown with arrows in FIG. 1, and a principle of the invention is that the traffic in one or both directions is inspected by a node or function in a device in the system such as, for example, the GGSN. Since a goal of the invention is to mainly detect malware behaviour in traffic which is not to or from a browser based application in the UE, the inspection is preferably only carried out on such traffic. Another way of expressing this is to say that the inspection is preferably carried out on traffic which is not based on browser protocols such as HTTP, Hypertext Transfer Protocol, or WSP, Wireless Session Protocol.

Packets to or from the UE are inspected and classified according to certain rules, the classification being such that each packet is assigned what will here be referred to as a Service Identifier, an SI. Different kinds of inspection can be used to arrive at the proper SI for a packet, with some examples of inspection methods being Header Inspection, Deep packet inspection and Heuristic inspection.

These methods will be described in more detail in the following:

### Header Inspection

During header inspection, the Internet Protocol (IP) and the transport protocol headers of the inspected packet are analyzed and matched against the header rules configured for the user. If the packet can be classified based on the information in the IP and transport protocol headers, it is assigned an SI.

### Deep Packet Inspection

Deep packet inspection is an optional extension of the header inspection. Instead of assigning an SI, a header rule may result in the forwarding of a packet to deep inspection filter rules which are configured for the user. Through the deep inspection filter rules, the GGSN inspects traffic at application protocol level, meaning that, for example, HTTP or WSP traffic can be classified based on Uniform Resource Identifier, URI, information or on the specific operation used.

If the deep inspection is successful, the packet is assigned an SI. Deep inspection of several application layer protocols is already supported in available GGSNs, in which, for example HTTP, WSP, FTP, TFTP SMTP, POPS, RTSP, and SIP can be supported.

### Heuristic Inspection

The heuristic inspection is optional, and is based on a set of empirical patterns characterizing a particular protocol or application. It is an alternative for inspection of proprietary (e.g. Skype) or encrypted protocols that cannot be identified through header inspection or deep inspection.

The SI which is assigned to a packet to or from the UE will be based on one or more of the inspection parameters listed above. A main criterion for giving a packet an SI which indicates malware is that the packet is “non-browser” related traffic, e.g. traffic which does not use the HHTP or WSP protocols.

If the SI which is assigned to a packet to or from the user indicates malware, then the node of the invention starts a process for the user, by means of which, the next time that the user attempts to access a webpage (i.e. the next time that the user uses, for example, HTTP or WSP based traffic) the user will be redirected to a webpage which has been configured for such cases, usually an informational webpage that, for example, informs the user that the UE has sent and/or received suspicious traffic, and recommending the user to take the necessary action, such as contacting the system operator or downloading software that will clean out malware.

The mechanism for assigning an SI to a packet may be seen as a filter, which can detect the behaviour of suspicious traffic. Naturally, the filters will need to be updated, which can suitably be done by the operator of the system.

As an example, a configuration for header level detection of malware which is known and frequent at the time of writing is given in table 1 below, which shows commonly occurring traffic which originates from malware. Packets which exhibit these features may all be given one and the same SI, which is an SI that indicates malware, for example SI=666.

The process described earlier will then be started for the UE which is the source or destination of packets whose SI=666. Packets with SIs which indicate a “clean bill of health” will be processed as normal.

TABLE 1
Examples of malware behavior

| | L4- | | |
|---|---|---|---|
| IP-adr | protocol | Ports | Remark |
| any to | TCP | 5554, | Sasser |
| any | | 9995-9996 | |
| any to | TCP | 2556 | Bagle.m, n, o, t etc. |
| any | | | backdoor Trojan |
| any to | TCP | 2745 | Bagle.k backdoor |
| any | | | Trojan |
| any to | TCP | 8866 | Bagle.b backdoor |
| any | | | Trojan |
| any to | TCP | 3127 | Mydoom* backdoor |
| any | | | Trojan |
| any to | TCP | 3333, 4444 | Blaster |
| any | | | |
| any to | TCP | 6531, 6551 | Hale backdoor Trojan |
| any | | | |
| any to | TCP | 48522, 5555 | Hale backdoor Trojan |
| any | | | |
| any to | TCP | 135, 593 | RPC/DCOM exploits |
| any | | | |
| any to | UDP | 996 to 999 | Sobig |
| any | | | |
| any to | TCP | 1080 | Bugbear |
| any | | | |
| any to | TCP | 6129 | Dameware RAT |
| any | | | |
| any to | UDP | 1434 | Slammer/W32.SQLE |
| any | | | xp.Worm |
| any to | UDP | 135 | Windows Messenger |
| any | | | Spam |
| any to | TCP | 135 | Portmapper exploits |
| any | | | |
| any to | TCP | 139 | SMB over Netbios |
| any | | | exploits |
| any to | UDP | 137-138 | SMB over Netbios |
| any | | | exploits |
| any to | TCP | 445 | SMB over TCP/IP |
| any | | | exploits |
| any to | UDP | 69 | Cirebot IRC backdoor |
| any | | | Trojan |
| any to | TCP | 69, 57005 | Cirebot IRC backdoor |
| any | | | Trojan |
| any to | TCP | 8719 | Winshell.50 backdoor |
| any | | | Trojan |

Some specific examples of embodiments of a device of the invention will now be given. A GGSN will usually comprise a function known as PCEF, Policy and Charging Enforcement Function, in which it is particularly advantageous to integrate the node of the invention, since the PCEF is already configured to inspect packets for reasons of charging and authorization. Thus, in the examples given below, the invention will be shown as being integrated in the PCEF.

### First Example of an Embodiment, “Stand Alone”-Solution

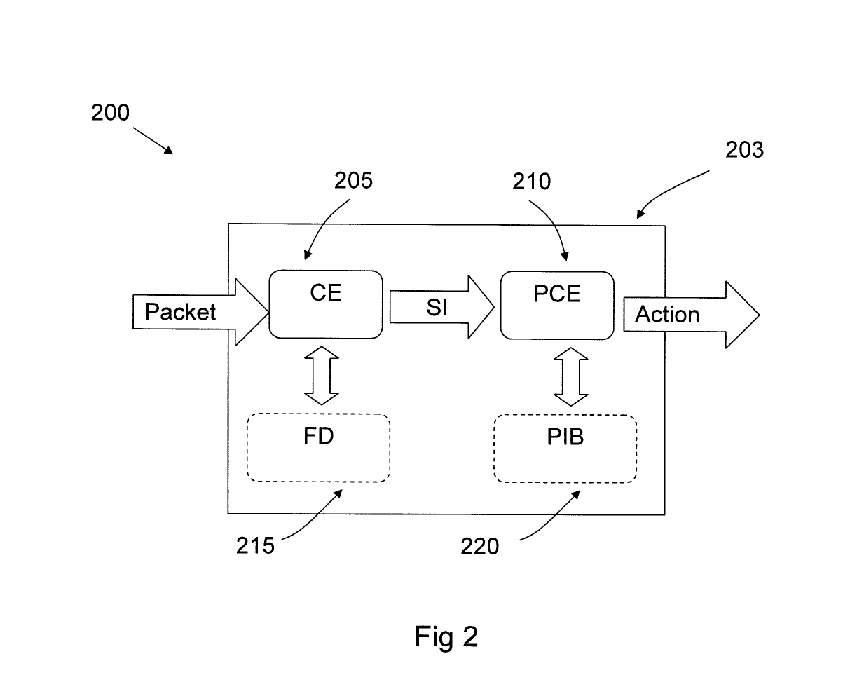

FIG. 2 shows a basic block diagram of a PCEF node 200 of the invention, which can be comprised in a system gateway such as a GGSN in the 2g/3G-case. Those function blocks of the PCEF node 200 which will be redesigned in a system of the invention are indicated by means of dashed lines. The function blocks will also be described below.

A prior art PCEF comprises a Classification Engine 205, CE, which classifies packets and assigns them SIs, Service Identifiers, based on filter definitions which the CE receives from a set or database of filter definitions, FD 215. The filter definitions 215 will be amended by means of the invention, in order to include the behaviour of known malware, for example those of table 1 above.

Thus, by means of the definitions in the FD 215, the CE 205 arrives at an SI for a packet, and the packet is together with its SI sent to the PCE 210, Policy and Charging Engine.

Assume now, in order to illustrate the example of FIG. 2 further, that there are four filters in the filter definition database 215. Thus, there are four possible SI outputs from the CE, which can be exemplified as follows:

| Filter Number | SI output |
|---|---|
| 1 | 1 |
| 2 | 2 |
| 3 | 100 |
| 4 | 666 |

A prior art PCE 210 uses a Policy and Information Base 220, PIB, in order to find the correct policy for a packet with a certain SI. The PIB 220 will be amended in a PCEF of the invention, in order to incorporate the proper policies for malware packets.

In the present example, SIs 1, 2 and 100 are indicative of harmless traffic, while a packet that lives up to the definitions of filter number 4 is a packet that fits the description of malware and thus receives an SI indicative of this, for example SI666.

An example of a PIB 220 for use in the PCEF 200 is given below, with the added feature that the traffic in the system 100 in which the PCEF 200 can be applied, there can be both 2G-GPRS or 3G-GPRS traffic, also referred to as different kinds of Radio Access Type, RAT. In the example below, it will be assumed that SIs 1, 2 and 100 are indicative of traffic which can be redirected, i.e. they are, for example, traffic based on the HTTP or WSP protocols.

In the PIB of the example below, traffic is treated as usual as long as no malware-related traffic is detected through classification of a packet with SI 666. If one or more packets are classified with SI 666, then all succeeding (relevant) traffic will be redirected to a webpage where, for example, the user of the UE is informed that his/her terminal has sent or received suspicious traffic which potentially originates from malware, and the user is advised to take appropriate action. This means that the next time that the user initiates a browser session he/she will immediately be informed, although in other embodiments, the redirect time can be set for some other point in time.

In one embodiment, when a redirect is carried out, a reset-timer will be initiated. When the timer expires, the packet count for SI 666 (or some other malware SI) will be reset. During the time that the timer is active, i.e. counts down, the user will not be redirected again. The reason for this would be not to block the user from continuing his/her session on the web. If traffic from malicious software is detected again when the timer has expired, the user will be redirected again.

### Example of a PIB

### Policy Information Base, PIB

### No Previous Packets with SI 666 OR Reset Timer not Expired

| SI | Action |
|---|---|
| 1 | permit |
| 2 | permit |
| 100 | permit |
| 666 | permit, initiate process |
| | for user |

### Previous Packets with SI666 AND Reset Timer Expired/not Started

| SI | Action |
|---|---|
| 1 | redirect, start timer, set “previous packet with 666” = 0 |
| 2 | redirect, start timer, set “previous packet with 666” = 0 |
| 100 | redirect, start timer, set “previous packet with 666” = 0 |
| 666 | permit, initiate process for user, |
| | set “previous packet with 666” = 0 |

### Second Example of an Embodiment

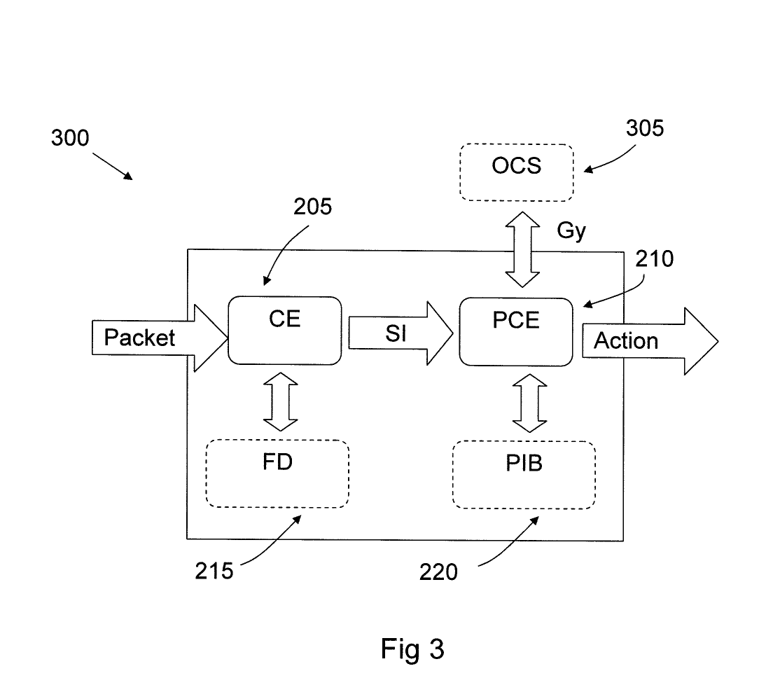

In this embodiment, the PCEF of the invention is also integrated in a system gateway such as a GGSN if the system is a 2G/3G-system. Thus, FIG. 3, which shows a block diagram of a PCEF 300 with the inventive node has many blocks in common with the embodiment shown in FIG. 2. Blocks which the PCEF 300 of FIG. 3 has in common with the PCEF of FIG. 2 have retained their reference numerals from FIG. 2. As in FIG. 2, blocks which are amended in an inventive PCEF are shown with dashed lines in FIG. 3.

A difference in the PCEF 300 as compared to the PCEF 200 of FIG. 2 is that the PCEF 300 comprises or makes use of an additional node 305, a so called OCS, Online Charging System. Such nodes exist previously, but the OCS 305 is amended to perform according to the invention, as will be explained below.

The interface (prior art) between the PCEF 300 and the OCS 305 is known as the Gy interface. The information on a packet which is sent from the PCEF comes from the PCE 210, and is known as the packet's Rating Group, the RG.

In the embodiment of FIG. 3, a packet which arrives at the PCEF 300 is still assigned an SI by the FD 215, as explained in connection with the embodiment of FIG. 2. The packet and its SI are then sent to the PIB 220, which however has a slightly different function in this embodiment: the objective of the PIB 220 here is to match the SI of a packet with a corresponding RG. Thus, the modification of the PIB 220 as compared to prior art will here comprise enabling the PIB 220 to assign RGs to SIs which indicate malware, such as, for example, SI 666.

At present (prior art), an OCS can respond in the following ways to an RG from the PCE:
Grant requests for the RG,
Refuse to grant requests for the RG,
Order a redirect for the RG

The invention could be implemented using the OCS 305 in the following manner: Assume that the filter definitions FD 215 include filters for malicious software as shown in FIG. 3, and that SI 666 is mapped to (for example) RG 666 by the PIB 220.

When a packet's SI is classified as 666 (or some other SI which is indicative of malware), the PCE 210 will request credits for RG 666 over the Gy interface. Credit may then be granted by the OCS 305 for this RG for a period of time which is, for example, equal to the reset-timer discussed in connection with example 1 above, i.e. the “stand-alone” solution.

The next time that the user initiates a browser session (HTTP or WSP) and the PCE 210 requests credits from the OCS 305 for this session, the OCS 305 will not grant any credits but will instead initiate a one-time redirect to, for example, a webpage where the user of the UE is informed that his/her terminal is sending or receiving suspicious traffic which potentially has originated from malware, and advising the user to take appropriate action. After the redirect, the user may continue the session (credits will be granted).

If the user deals with the problem immediately, the traffic from the malware will stop, which will eventually cause the credits for RG 666 to “time out”, and the PCE 210 will consequently inform the OCS 305 of this. However, if the user does not fix the malware problem, the credit for RG 666 will be exhausted and will thus result in an update request where the PCE 210 requests more credits for RG 666. This will inform the OCS 305 that the problem has not been solved, and the user may again be redirected to the informational web page.

Thus, the basic behaviour of the PCEF 300 is the same as in the stand alone case, i.e. the PCEF 200, although in this example the amendments to the prior art PCEF now also include amending an OCS and letting the PCEF 300 utilize the amended OCS 305 to achieve the goals of the invention.

### Third Example of an Embodiment

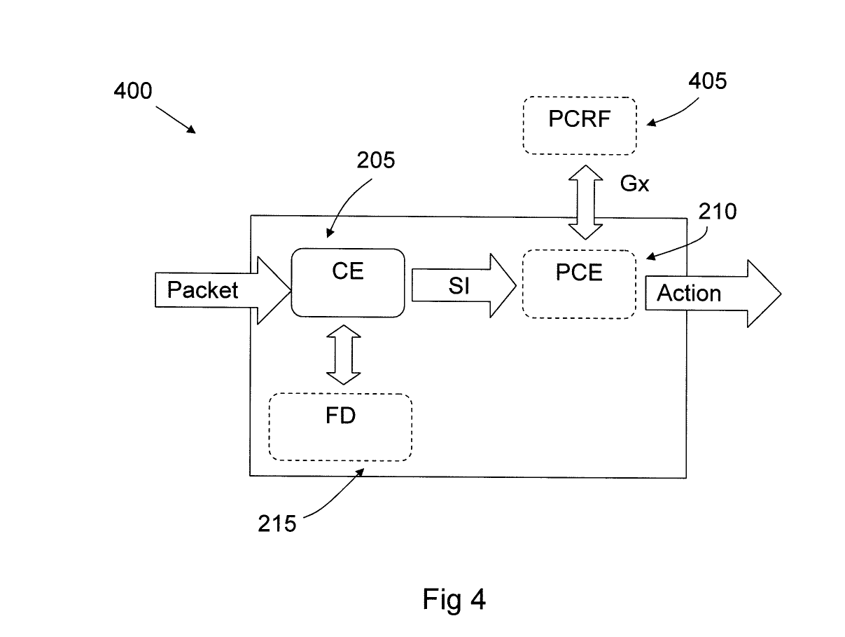

A third example of an embodiment of the invention will now be described with reference to FIG. 4.

FIG. 4 shows an embodiment in which the PCEF node of the invention is also integrated in a system gateway such as a GGSN. Thus, in FIG. 4, which shows a block diagram of a PCEF 400 as the inventive node, the PCEF 400 has many blocks in common with the embodiments shown in FIGS. 2 and 3. Blocks which the PCEF 400 of FIG. 4 has in common with the PCEF of FIG. 2 have retained their reference numerals from FIG. 2. As in FIG. 2, blocks which are amended in an inventive PCEF are shown with dashed lines in FIG. 3.

In the embodiment 400, the PCEF also comprises or makes use of a so called PCRF node 405, i.e. a node for Policy and Charging Rules Function, which in the prior art is accessed by the PCE 210 via an interface known as the Gx interface for supplying the PCE with policy information regarding charging and authorization of traffic. Thus, in prior art, when a UE initiates a session, the PCE requests this policy information from the PCRF via the Gx interface.

The PCE may request updates of the policy information from the PCRF, for example at session updates, but the PCRF may also update the policy update at will, for example as a result of external triggers, such as, for example, subscription updates.

According to the invention, the PCE 210 and the PCRF 405 are altered in their handling of the Gx interface, so that they (PCE and PCRF) can use the Gx interface for exchanging messages regarding SIs which are indicative of malware.

Assume now that the filter definitions in the FD 215, as previously, include filters for malware, and that malware will be assigned one or more special “malware SIs”, such, as for example 666. The following is then an example of a possible scenario in the PCEF 400:
1. At session start for a UE, a Gx session is initiated by the PCE 210 towards the PCRF 405. The following policy information is received by the PCE over the Gx interface:

| Policy | | |
|---|---|---|
| Rule | SI | Authorization rule |
| 1 | 1 | Authorized |
| 2 | 2 | Authorized |
| 100 | 100 | Authorized |
| 666 | 666 | Authorized + report usage |
| | | after 1 packet |

In this example, when a packet is classified with SI 666, the Policy and Charging Engine will authorize it, but the event will also trigger a report over the Gx interface. Both the trigger mechanism and the mechanism for the report are parts of the invention.
2. The PCRF 405 will respond to the report with new policy information to the PCE 210, as follows:

| Policy Rule | SI | Authorization rule |
|---|---|---|
| 1 | 1 | Redirect + report after one packet |
| 2 | 2 | Redirect + report after one packet |
| 100 | 100 | Redirect + report after one packet |
| 666 | 666 | Authorized |

According to these new rules which are triggered by the malware SI, traffic which can be redirected (e.g. “browser based traffic”, such as HTTP and WSP based traffic) will now be redirected to a webpage where the user is, for example, informed that his/her terminal is sending or receiving suspicious traffic which potentially originates from malware, and that appropriate action should be taken. In effect, this means that the next time that the user initiates a browser session he/she can be informed immediately, or, alternatively, at a later point in time.
3. When a redirect according to the rules above takes place, the PCE will request another update over the Gx interface. The PCRF will respond with new policy information as follows:

| PCC Rule | SI | Authorization rule |
|---|---|---|
| 1 | 1 | Authorized |
| 2 | 2 | Authorized |
| 100 | 100 | Authorized |
| 666 | 666 | Authorized |

Again, all traffic will be authorized, and a timer will be started in the PCRF. Upon expiration of the timer, the following policy information will be “pushed” down to the PCE:

| PCC Rule | SI | Authorization rule |
|---|---|---|
| 1 | 1 | Authorized |
| 2 | 2 | Authorized |
| 100 | 100 | Authorized |
| 666 | 666 | Authorized + report usage after |
| | | 1 packet |

As can be seen, this is the same policy information that was provided at session setup. Accordingly, if a packet is classified as SI 666, the same procedure will take place, and the user will be redirected again.

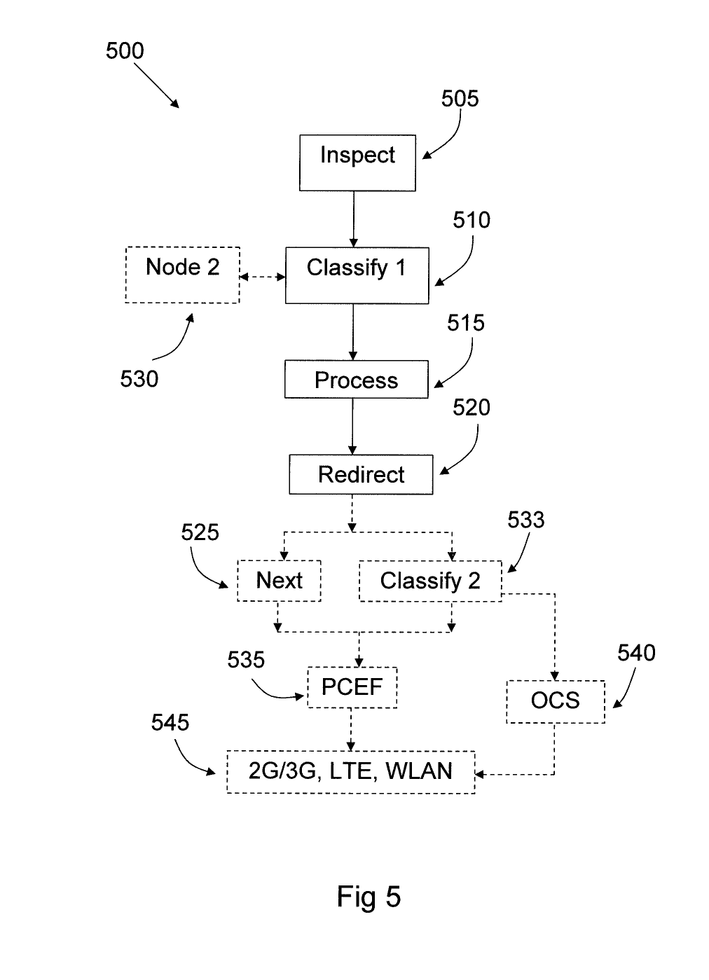

FIG. 5 shows a schematic flow chart of a generalized method 500 of the invention. The method 500 is intended for use in a cellular communications system, and, as indicated in step 505, comprises inspection of traffic packets to and from users in the system, as well as, step 510, a first classification of said packets according to predetermined rules.

The method 500 also initiates, step 515, a process for a user who is the destination or source of a packet which is classified in the first classification of step 510 as belonging to a specific kind of traffic which has as one of its characteristics that the system cannot redirect the packet from its intended destination to another destination. The process is such that at a later point in time, when the user 110 attempts to access a webpage, the user is redirected, step 520, to a predefined webpage.

In one embodiment, as indicated in step 525, the later point in time when a user is redirected occurs the next time that the user attempts to access any webpage.

As shown in step 533, the method 500 may also comprise a secondary classification of the packets, using said secondary classification for making a decision on whether or not said process should be initiated.

In an alternative embodiment, as indicated in step 530, rules for the first classification are received, as shown in step 530, from an additional node in the system, including rules for the initiation of said process.

As indicated in step 535, the method 500 can be applied in a device for PCEF, Policy and Charging Enforcement Function, which, as indicated in step 545, can be embodied in a cellular system such as one of the following: 2G/3G, WLAN or LTE. As shown in step 540, the secondary classification mentioned above can suitably be made in a node for OCS, Online Charging System.

The invention is not limited to the examples of embodiments described above and shown in the drawings, but may be freely varied within the scope of the appended claims. For example, the invention can be applied not only on a 2G/3G-system, but can also be applied in systems such as WLAN or LTE. Examples of gateways in these systems in which the PCEF could be employed are the PDG, Packet Data Gateway, in WLAN systems, and in LTE systems, a suitable gateway for the PCEF of the invention is the PDN-GW, the Packet Data Network Gateway.

1. A device for use in a cellular communications system, the device being provided with means for inspecting traffic packets to and from users in the system and for a first classification (SI) of said packets according to predetermined rules, the device being characterized in that it also comprises means for initiating a process for a user who is the destination or source of a packet which is classified in said first classification as belonging to a specific kind of traffic which has as one of its characteristics that the device cannot redirect the packet from its intended destination to another destination, said process being such that at a later point in time, when said user attempts to access a webpage, the user is redirected to a predefined webpage.

2. The device of claim 1, in which said later point in time when a user is redirected occurs the next time that the user attempts to access any webpage.

3. The device of claim 1, being a device for PCEF, Policy and Charging Enforcement Function.

4. The device of claim 3, being a PCEF in a system gateway in one of the following cellular communications system: 2G/3G, WLAN or LTE.

5. The device of claim 1, also being provided with means for carrying out a secondary classification of said packets, the device additionally comprising a first additional node which is supplied with the results of said secondary classification, and which first additional node in return supplies the device with a decision on whether or not said process should be initiated.

6. The device of claim 5, with the first additional node being a node for OCS, Online Charging System.

7. The device of claim 1, which receives rules for said first classification from a second additional node in the system, including rules for the initiation of said process.

8. The device of claim 7, with the second additional node being a node for PCRF, Policy and Charging Rules Function.

9. A node for OCS, Online Charging System, in a cellular communications system, the OCS node being adapted to receive, from a device in the system, requests for credit for a user's packets, said requests being based on a classification of a packet by said device, the OCS node being adapted to grant credits for packets with a certain classification for a certain predetermined period of time.

10. The OCS node of claim 9, being adapted to initiate a redirect of the user's traffic to a certain predetermined webpage if credit is requested multiple times for one and the same user with packets with a classification which indicates malware.

11. The OCS node of claim 9, in which said classification is the RG classification, Rating Group, which is exchanged with said device over the Gy interface of the OCS node.

12. A node for PCRF, Policy and Charging Rules Function in a cellular communications system, the PCRF node being adapted to supply a device in the system with a first set of rules for charging and authorization of traffic in the form of packets, the PCRF node also being adapted to receive reports from said device on packets which the device has assigned a certain classification, the node also being adapted to supply said device with a second set of rules for packets upon receiving such reports.

13. The PCRF node of claim 12, in which said second set of rules comprise instructions to redirect redirectable traffic to a certain predefined webpage.

14. The PCRF node of claim 13, being adapted to receive a report from said device that a redirect has taken place, upon which the PCRF node issues a new set of rules to the device, instructing the device to cease redirecting.

15. The PCRF node of claim 14, which comprises a timer which is initiated when the device is instructed to cease redirecting, so that the PCRF node, upon expiration of the timer, will issue said second set of rules to the device.

16. A method for use in a cellular communications system, comprising inspection of traffic packets to and from users in the system and a first classification of said packets according to predetermined rules, the method being characterized in that it also initiates a process for a user who is the destination or source of a packet which is classified in said first classification as belonging to a specific kind of traffic which has as one of its characteristics that the system cannot redirect the packet from its intended destination to another destination, with said process being such that at a later point in time, when said user attempts to access a webpage, the user is redirected to a predefined webpage.

17. The method of claim 16, according to which said later point in time when a user is redirected occurs the next time that the user attempts to access any webpage.

18. The method of claim 16, applied in a device for PCEF, Policy and Charging Enforcement Function.

19. The method of claim 18, with the PCEF being used in a system gateway in one of the following cellular communications system: 2G/3G, WLAN or LTE.

20. The method of claim 16, also comprising a secondary classification of said packets and using said secondary classification for making a decision on whether or not said process should be initiated.

21. The method of claim 20, according to which the secondary classification is made in a node for OCS, Online Charging System.

22. The method of claim 16, according to which rules for said first classification are received from an additional node in the system, including rules for the initiation of said process.

23. The method of claim 22, with the additional node being a node for PCRF, Policy and Charging Rules Function.
